(19) United States
(12) Patent Application Publication
(10) Pub. No.: US 2009/0064291 A1
(43) Pub. Date: Mar. 5, 2009

(54) System and method for relaying authentication at network attachment

(76) Inventor: Mark Frederick Wahl, Austin, TX (US)

Correspondence Address: Mark Wahl, P.O. Box 90626, Austin, TX, 78709, US

(21) Appl. No.: 12/229,766

(22) Filed: Aug. 27, 2008

Related U.S. Application Data
(60) Provisional application No. 60/966,427, filed on Aug. 28, 2007.

(51) Int. Cl. H04L 9/32; G06F 21/00

(52) U.S. Cl. 726/5

(57) ABSTRACT

An information processing system for remote access computing comprising a network access server and a local authentication server is augmented with the capability for relaying authentication requests by tunneling interactions between the requesting client and an identity provider.

### CROSS-REFERENCE TO RELATED APPLICATIONS

This application claims the benefit of PPA Ser. No. 60/966,427, “System and Method for Relaying Authentication at Network Attachment”, filed Aug. 28, 2007 by the present inventor, which is incorporated by reference.

### FEDERALLY SPONSORED RESEARCH

Not applicable

### SEQUENCE LISTING OR PROGRAM

Not applicable

### BACKGROUND OF THE INVENTION

1. Field of the Invention

This invention relates generally to security in computer networks.

2. Prior Art

An Identity Metasystem is a collection of interoperable computing elements on a computer network which enables users of the services provided by the network to manage and exchange their digital identities. In an Identity Metasystem, an Identity Provider is a network server responsible for authenticating users, and a Relying Party is a network server which requires an authenticated user identity in order to provide service. A prior art definition of the Identity Metasystem specifies the mechanisms that enable a Relying Party to validate that a user requesting service from that Relying Party has been previously authenticated by an Identity Provider, in which the Relying Party is a web service based on the Simple Object Access Protocol (SOAP), or web server based on the Hypertext Transfer Protocol (HTTP). HTTP is specified by the document IETF RFC 2616 “Hypertext Transfer Protocol—HTTP/1.1” by R. Fielding et al of June 1999. The Hypertext Transfer Protocol is typically used by a web browser to communicate with a web server to retrieve Hypertext Markup Language documents from a web application.

The OpenID protocol framework is a prior art specification for the exchange of authentication information between services on the Internet which leverage HTTP. In the OpenID framework, a user is identified by a Uniform Resource Identifier of the “http” form which points to a document that contains the URI of the user's identity provider. The Uniform Resource Identifier is specified by the document IETF RFC 3986 “Uniform Resource Identifier (URI): Generic Syntax” by T. Berners-Lee et al of January 2005. The authentication protocol of OpenID is specified in the document “OpenID Authentication 1.1” by D. Recordon and B. Fitzpatrick of May 2006.

In a prior art system using the OpenID authentication protocol as illustrated in FIG. 2, a user (31) instructs their web browser (32) to contact a relying party application server (34). The user (31) enters their OpenID URI in the web browser, and the web browser (32) transmits it to the relying party application server (34). The relying party application server (34) redirects the web browser (32) to connect to the identity provider web server (36). The user (31) authenticates to the identity provider web server (36), and the web browser (32) is redirected back to the relying party application server (34). The relying party application server (34) receives from this redirect a response signed by the identity provider web server (36).

In a local area network based on the Institute of Electrical and Electronics Engineers, Inc. (IEEE) Ethernet standards for physical and data link network layers, computer systems are typically attached to the network either through a physical cable connection to a bridge, or to a radio connection to a wireless router. An example of an IEEE standard for a physical cable connection is IEEE 802.3u-1995: IEEE Standards for Local and Metropolitan Area Networks: Supplement to Carrier Sense Multiple Access with Collision Detection (CSMA/CD) Access Method and Physical Layer Specifications Media Access Control (MAC) Parameters, Physical Layer, Medium Attachment Units, and Repeater for 100 Mb/s Operation, Type 100BASE-T of 1995. An example of an IEEE standard for a radio connection is IEEE 802.11b-1999: Supplement to 802.11-1999, Wireless LAN MAC and PHY specifications: Higher speed Physical Layer (PHY) extension in the 2.4 GHz band of 1999. In both cases, the bridge and the wireless router each function as a media access control device. A media access control device implements control functions that determine whether a computer system that has been attached to a port on the device is permitted to communicate on the network. Recent devices implement the IEEE standard 802.1X-2004 Port-Based Network Access Control, which specifies how the media access control device can prevent unauthorized access by unrecognized computer systems. The device, termed the authenticator, will authenticate a computer system when that computer system, termed the supplicant, connects to it. If the supplicant successfully completes authentication with the authenticator, the supplicant will then be permitted to communicate with other computer systems on the network. If the supplicant does not complete authentication, the supplicant will not be permitted to further communicate with other computer systems on the network. IEEE standard 802.1X-2004 defines an encapsulation technique to carry protocol data units (PDUs) of the Extensible Authentication Protocol (EAP) over the LAN connection between the supplicant and the authenticator.

EAP, an authentication framework intended for use with data link protocols, is specified in the document IETF RFC 3748 “Extensible Authentication Protocol (EAP)” by B. Aboba et al of June 2004. Within the EAP framework, the Protected Extensible Authentication Protocol (PEAP) encapsulates the authentication information within an encrypted Transport Layer Security (TLS) tunnel between the supplicant and the authenticator. PEAP is specified in the document “Protected EAP Protocol (PEAP) Version 2” of A. Palekar et al of October 2004, located at “http://tools.ietf.org/html/draft-josefsson-pppext-eap-tls-eap-10”. TLS is specified in the document IETF RFC 2246 “The TLS Protocol Version 1.0” by T. Dierks et al of November 1998.

Existing prior art implementations of 802.1X with EAP and PEAP have been designed to have the network server forward the EAP PDUs it receives from supplicants to a local authentication server (46). As illustrated in FIG. 3, in a prior art implementation the local authentication server (46) may rely upon a local database (50) that stores the credentials of authorized users. In a prior art implementation, the network supplicant element (42) of the client (40) will use an EAP authentication mechanism to carry the user's identity and credentials to the local authentication server (46), that will compare those credentials with those stored for the user in the local database (50).

In some prior art implementations of 802.1X with EAP, the supplicants do not have accounts on the local database, and instead, the local authentication server will forward the authentication credentials to a remote authentication server via the Remote Authentication Dial In User Service (RADIUS) protocol. This protocol requires a pre-established trust relationship between the local authentication server and the remote authentication server. The RADIUS protocol is specified in the document IETF RFC 2865 “Remote Authentication Dial In User Service (RADIUS)” by C. Rigney et al of June 2000. The method of encapsulating EAP in RADIUS is specified in the document IETF RFC 3579 “RADIUS (Remote Authentication Dial In User Service) Support For Extensible Authentication Protocol (EAP)” by B. Aboba et al of September 2003.

A limitation of these prior art implementations is that they do not define how a user whose computer is connecting to an access point that requires 802.1X authentication can specify their identity provider. Furthermore, these prior art implementations are limited as they require the organizations which maintain the authentication credentials of users in their user communities to provide RADIUS servers accessible on the Internet to authenticate their users, and establish RADIUS trust relationships between the local authentication server and remote authentication server. Also, as the PDUs of the RADIUS protocol are carried in the UDP protocol above IP, they cannot be protected from eavesdropping or modification while in transit on the Internet using the Secure Sockets Layer (SSL) or Transport Layer Security (TLS) protocols.

### SUMMARY

This invention describes a method and system for relaying authentication of a network supplicant when that network supplicant attaches to a media access control device. In this invention, the OpenID protocols between the supplicant and their identity provider are carried in EAP PDUs from the supplicant to the authenticator.

### DRAWINGS—FIGURES

FIG. 1 is a diagram that illustrates the components of the system for relaying authentication at network attachment.

FIG. 2 is a diagram that illustrates the components of a prior art system for authentication.

FIG. 3 is a diagram that illustrates the components of a prior art system for authentication.

FIG. 4A, FIG. 4B, FIG. 4C and FIG. 4D are diagrams that illustrate the flow of protocol data units between a network supplicant and a local authentication server.

FIG. 5 and FIG. 6 are diagrams that illustrate the structure of protocol data units defined in this invention.

FIG. 7A and FIG. 7B are a flowchart illustrating the operation of a network supplicant.

FIG. 8A, FIG. 8B, FIG. 8C and FIG. 8D are a flowchart illustrating the operation of a thread in a local authentication server.

FIG. 9 is a diagram illustrating the display of an authentication page in the web browser generated by an identity provider web server.

FIG. 10 is a diagram illustrating the display of a completion page in the web browser generated by a local authentication server.

FIG. 11 is a diagram illustrating the components of a relying party network and its attachment to a client computer and an identity provider.

FIG. 12 is a diagram illustrating the components of a server computer system.

FIG. 13 is a diagram illustrating the components of a workstation computer system with a wireless network interface.

FIG. 14 is a diagram illustrating the components of a wireless access point.

FIG. 15 is a diagram illustrating the components of the relying party database component.

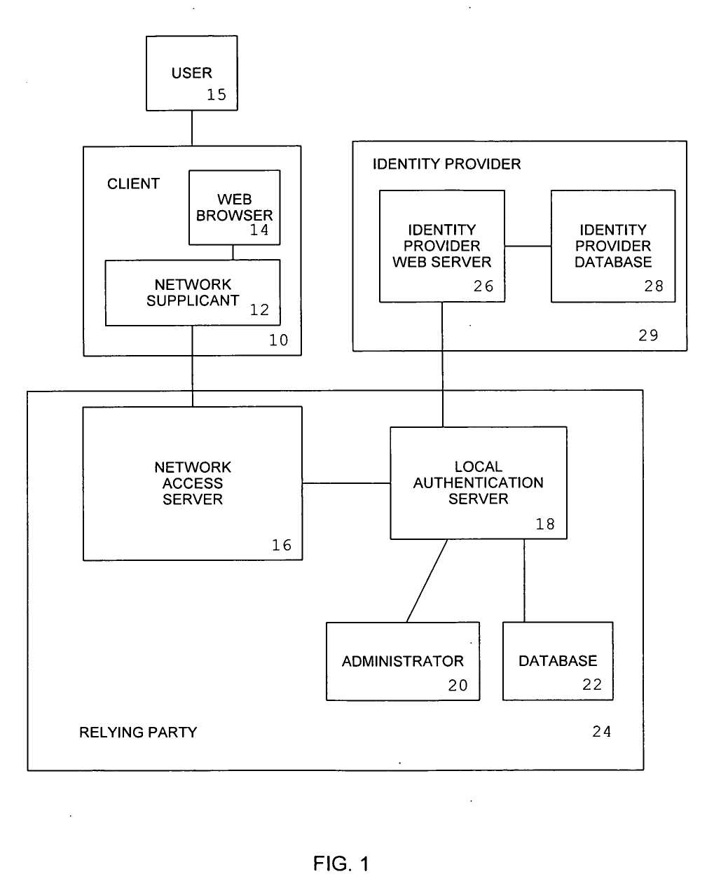

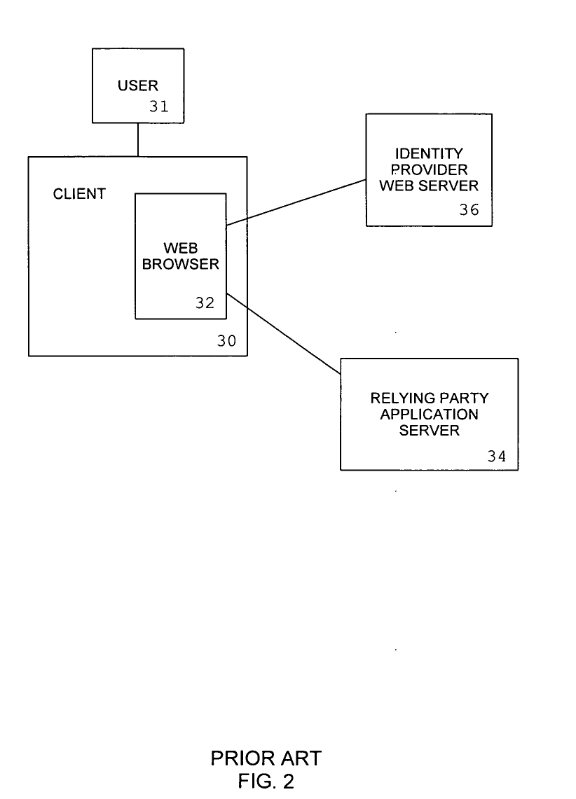

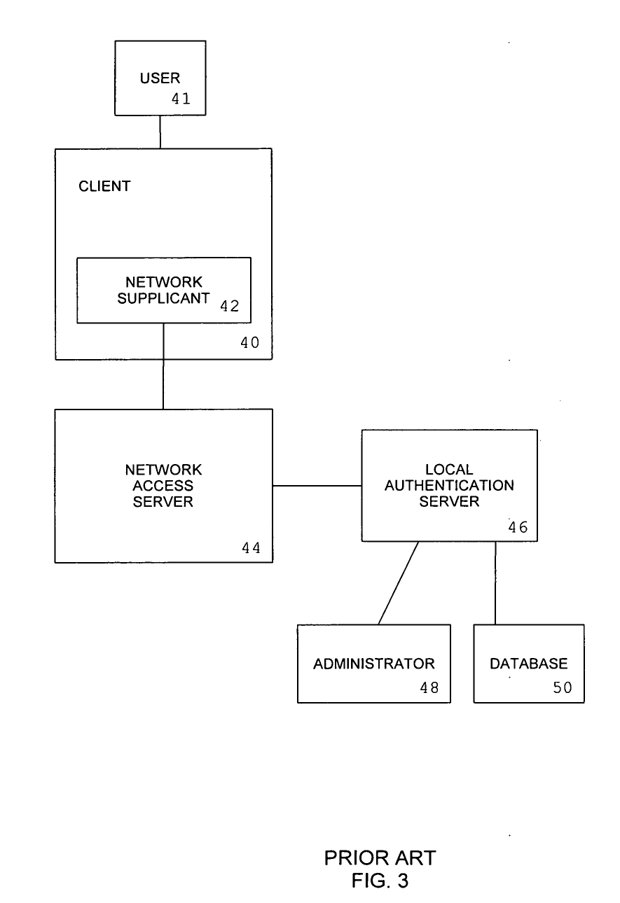

### DRAWINGS—REFERENCE NUMERALS

10 client system

12 network supplicant component

14 web browser component

15 user

16 network access server component

18 local authentication server component

20 administrator

22 relying party database component

24 relying party

26 identity provider web server

28 identity provider database

29 identity provider

30 client system

31 user

32 web browser component

34 relying party application server

36 identity provider web server

40 client system

41 user

42 network supplicant component

44 network access server component

46 local authentication server component

48 administrator

50 database

60 PDU of EAP-Request/Type=Identity

62 PDU of EAP-Response/Type-Identity

64 PDU of EAP-Request/Type=PEAP; PEAP Start

66 PDU of EAP-Response/Type=PEAP; TLS client_hello

68 PDU of EAP-Request/Type=PEAP; TLS server_hello, certificate, server_hello_done

70 PDU of EAP-Response/Type=PEAP; TLS client_key_exchange, change_cipher_spec, finished

72 PDU of EAP-Request/Type=PEAP; TLS change cipher_spec, finished; EAP-Payload TLV: EAP-Request/Type=EXPANDED; Vendor-Id=21008, Vendor-Type=Request-URI

74 PDU of EAP-Payload TLV: EAP-Response/Type=EXPANDED; Vendor-Id=21008, Vendor-Type=Request-URI

76 PDU of EAP-Payload TLV: EAP-Request/Type=EXPANDED; Vendor-Id=21008, Vendor-Type=Redirect

78 PDU of EAP-Payload TLV: EAP-Response/Type=EXPANDED; Vendor-Id=21008, Vendor-Type=Redirect

80 PDU of EAP-Payload TLV: EAP-Request/Type=EXPANDED; Vendor-Id=21008, Vendor-Type=Encap-DNS

82 PDU of EAP-Payload TLV: EAP-Response/Type=EXPANDED; Vendor-Id=21008, Vendor-Type=Encap-DNS

84 PDU of EAP-Payload TLV: EAP-Request/Type=EXPANDED; Vendor-Id=21008, Vendor-Type=Encap-DNS

86 PDU of EAP-Payload TLV: EAP-Response/Type=EXPANDED; Vendor-Id=21008, Vendor-Type=Encap-DNS

90 PDU of EAP-Payload TLV: EAP-Request/Type=EXPANDED; Vendor-Id=21008, Vendor-Type=Encap-IP

92 PDU of EAP-Payload TLV: EAP-Response/Type=EXPANDED; Vendor-Id=21008, Vendor-Type=Encap-IP

94 PDU of EAP-Payload TLV: EAP-Request/Type=EXPANDED; Vendor-Id=21008, Vendor-Type=Encap-IP

96 PDU of EAP-Payload TLV: EAP-Response/Type=EXPANDED; Vendor-Id=21008, Vendor-Type=Encap-IP

100 PDU of EAP-Payload TLV: EAP-Request/Type=EXPANDED; Vendor-Id=21008, Vendor-Type=Complete

102 PDU of EAP-Payload TLV: EAP-Response/Type=EXPANDED; Vendor-Id=21008, Vendor-Type=Complete

104 PDU of Result TLV; Crypt-Binding TLV; Intermediate-Result TLV

106 PDU of Result TLV; Intermediate-Result TLV; Crypto-Binding TLV

108 PDU of EAP-Success

110 PDU of EAP Expanded

112 EAP PDU Parameter TLV

114 EAP PDU payload of identity URI

116 EAP PDU payload of link IP address and completion URI

118 EAP PDU payload of encapsulated DNS

120 EAP PDU payload of encapsulated IP

122 EAP PDU payload of completion indication

124 EAP PDU payload of redirect URI

300 authentication page display

310 completion page display

400 relying party network

402 client computer

404 administrator workstation

406 wireless access point

408 LAN switch

410 firewall router

412 local authentication server computer

414 ISP

416 identity provider web server computer

418 Internet

500 computer

502 CPU

504 hard disk interface

506 system bus

508 BIOS ROM

510 hard disk

512 operating system software on hard disk

514 application software on hard disk

516 RAM

518 operating system software in memory

520 application software in memory

522 network interface

524 LAN switch

550 display

552 computer

554 CPU

556 video interface

558 system bus

560 USB interface

562 hard disk interface

564 BIOS ROM

566 hard disk

568 operating system software on hard disk

570 application software on hard disk

572 wireless network interface

574 random access memory

576 operating system state in memory

578 application software state in memory

580 keyboard

582 mouse

584 antenna

600 wireless access point

602 CPU

604 flash memory

606 system bus

608 RAM

610 wireless network interface

612 network interface

614 antenna

616 LAN switch

700 authorization table

### DETAILED DESCRIPTION

This invention describes a method and system for authentication of a network supplicant when that network supplicant attaches to a media access control device. In this invention, the network supplicant will provide the user's OpenID URI to the network access server component of a relying party, which will relay it to the local authentication server component. The local authentication server component will validate that the URI is an OpenID, and establish a temporary IP tunnel within EAP between a web browser on the client system and the Internet, to allow the user to authenticate to their identity provider. When the identity provider returns a completion URI to the client's web browser and the client's web browser attempts to establish an HTTP or HTTPS connection to that URI, the local authentication server will receive and parse this response, and terminate the temporary IP tunnel.

The components of this invention are:

a client system (10),

a network supplicant component (12) of the client system,

a web browser component (14) of the client system,

a user (15) of the client system,

a relying party (24),

a network access server component (16) of the relying party,

a local authentication server component (18) of the relying party,

an administrator (20) of the relying party,

a local database component (22) of the relying party, and

an identity provider web server (26).

The client (10) is typically a standalone computer system. Examples of such standalone computer systems include laptops, personal digital assistant devices (PDAs), mobile phones with 802.11 capability, and workstation computers.

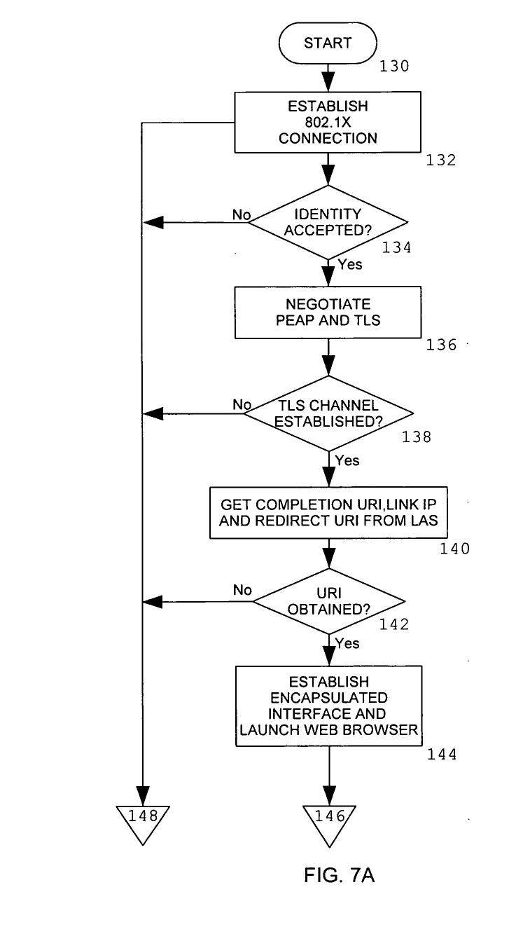

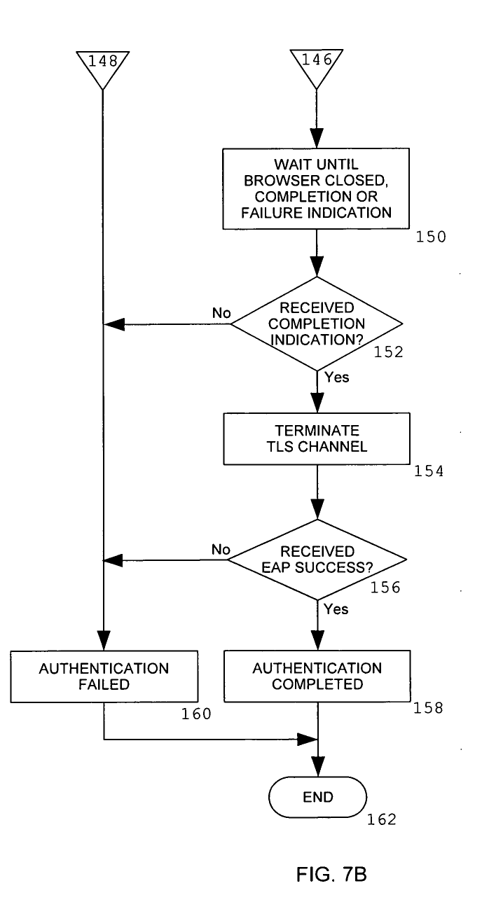

The network supplicant (12) is a component of the operating system of the client (10). The supplicant will start negotiation when it is notified by the data link layer of the client that a packet has been received over an Ethernet connection from an authenticator. The network supplicant will handle the negotiation of authentication over this connection, and if the authentication is successfully completed, the authenticator will grant the client access to the network. The behavior of the supplicant is illustrated by the flowchart of FIG. 7A and FIG. 7B.

The network access server (16) is a component of a computer or device attached to the network of the relying party. It may be integrated with a media access control device, or alternatively a media access control device may forward EAP PDUs to the network access server. Typically in a large enterprise network there may be one or more network access servers for each network with an attached network access point, such as a wireless access point. When a supplicant connects to a port on a media access control device, the network access server will send an EAP-Request/EAP-Type=Identity PDU to the supplicant, and the supplicant will reply with an EAP-Response/EAP-Type=Identity PDU. The network access server will send this and subsequent EAP PDUs to a local authentication server (18).

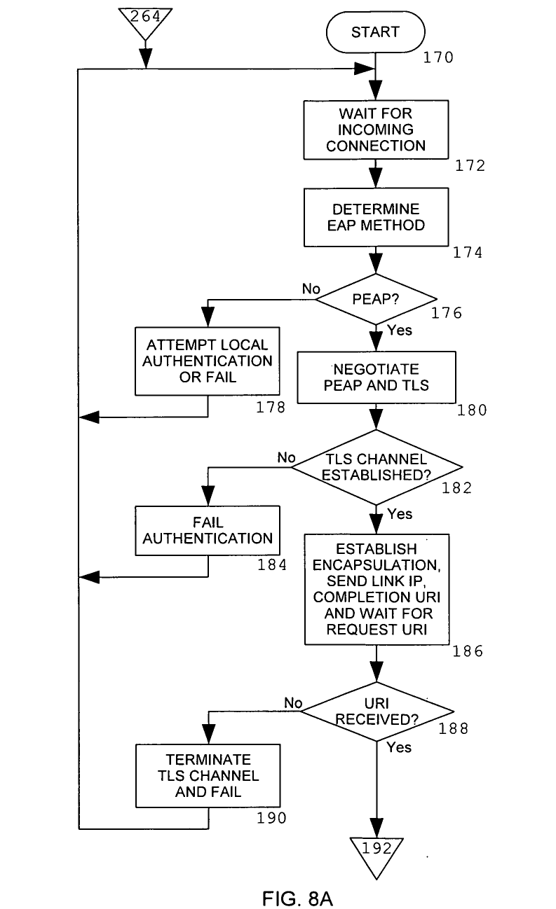

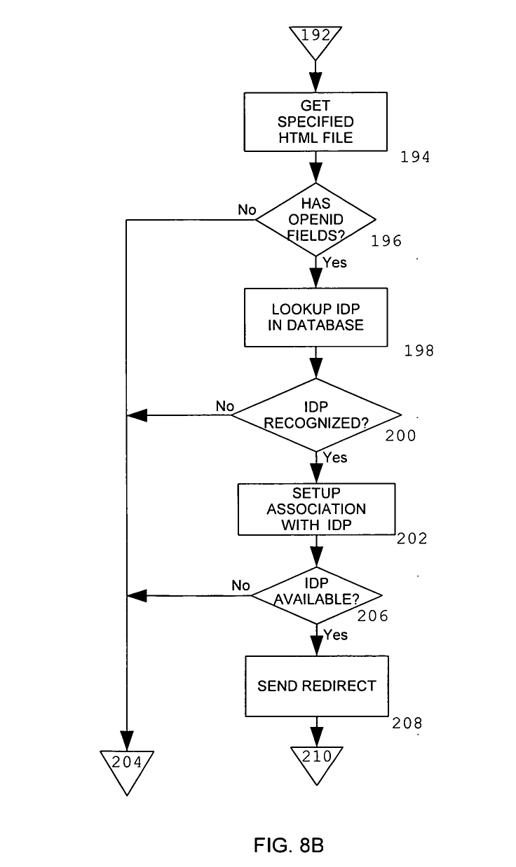

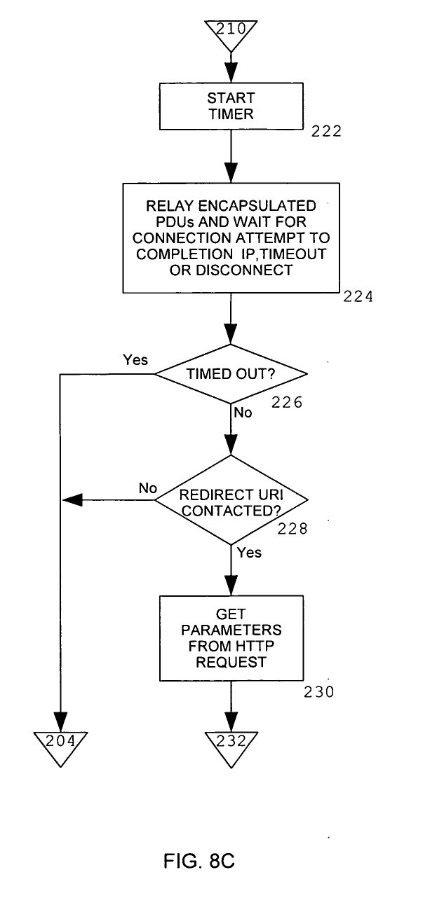

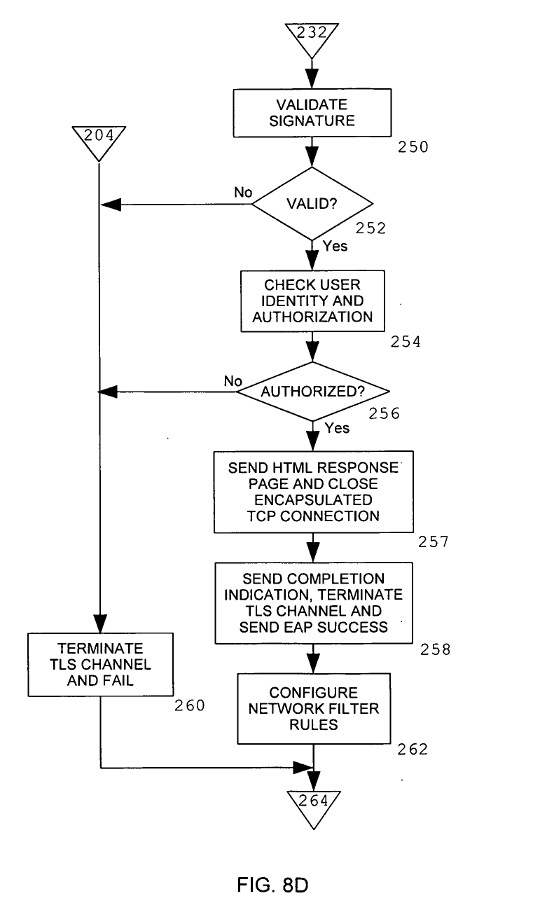

The local authentication server (18) is a component of a computer or device attached to the network of the relying party. The local authentication server receives RADIUS requests from the network access server (16). The behavior of the local authentication server is illustrated by the flowchart of FIG. 8A, FIG. 8B, FIG. 8C and FIG. 8D.

The local database (22) is a component of a computer or device attached to the network of the relying party. The local database comprises a set of local authentication credentials for the authorized users who do not have an external identity provider. The local database also comprises a set of records, each with an identifier of an authorized identity provider. The local database also comprises a set of records which specify the authorization rights of users.

The authorization table (700) in the local database has one row for each identity provider or user with access rights to the network. The columns of this table are:

IDP URL: the URL of the identity provider,

USER URL: the OpenID unique identifier for the user,

ACCESS RIGHTS: the access rights of the user, and

STATUS: the status of the user's access rights grant to the network.

The identity provider web server (26) is a web server that implements the HTTP or HTTPS (HTTP over TLS) protocols, and implements the OpenID authentication protocol as an identity provider. It leverages the contents of the identity provider database (28), which can be implemented as a relational database holding the authentication credentials of the users managed by the identity provider.

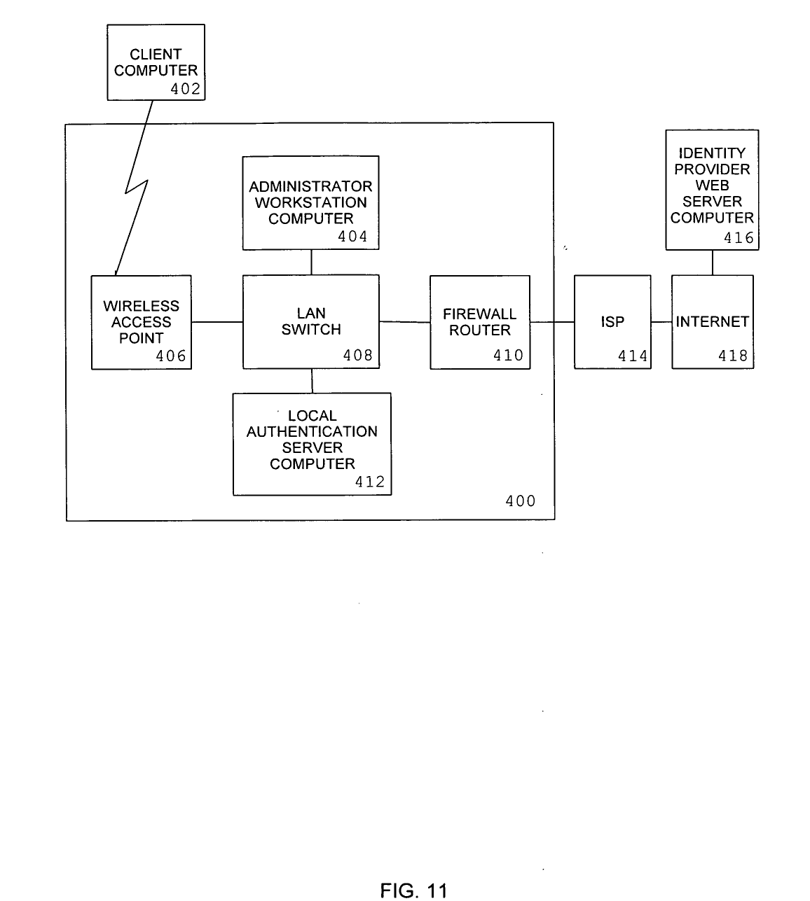

The components of this invention may be implemented as software running on one or more computer systems attached to a network. An example network is illustrated by the diagram of FIG. 11. A wireless access point (406), a local authentication server computer (412), an administrator workstation (404) and a firewall router (410) are connected to a LAN switch (408) of a relying party network (400). The firewall router (410) provides the relying party network with Internet connectivity (418) via an Internet Service Provider (414). A client computer (402) connects to the wireless access point (406) via a wireless network protocol, such as 802.11b. In this network, the web browser (14) and network supplicant (12) can be implemented as software running on the client computer (402), the network access server (16) can be implemented as software running on the wireless access point (406), the local authentication server (18) and database (22) can be implemented as software running on the local authentication server computer (412), and the identity provider web server (26) and database (28) can be implemented as software running on the identity provider web server computer (416).

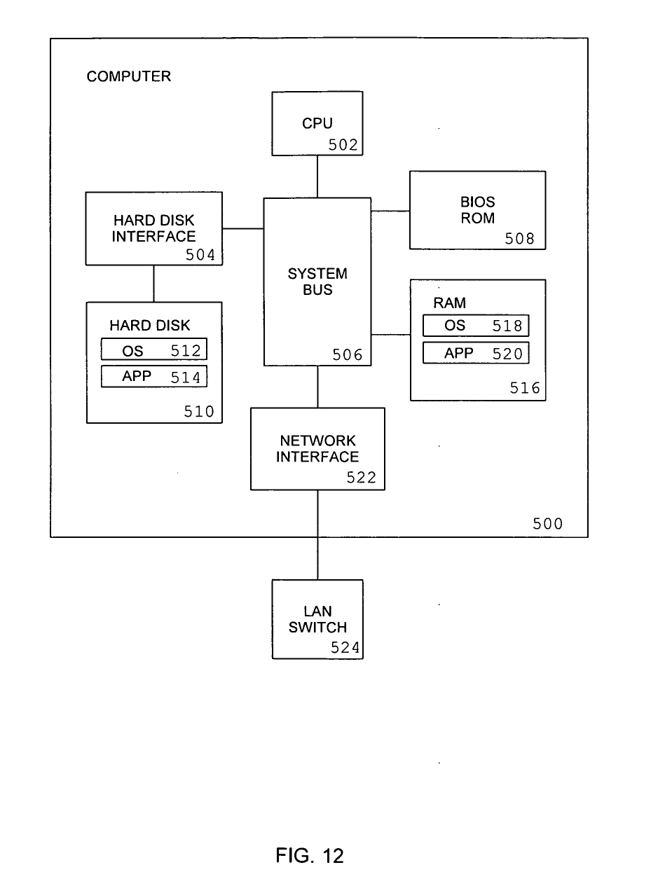

The diagram of FIG. 12 illustrates the typical components of a computer for running server software applications. The components of the computer (500) include a central processing unit (502), a hard disk interface (504) to a hard disk (510), a system bus (506), a BIOS ROM (508), random access memory (516), and a network interface (522) to a LAN switch (524). The hard disk stores the persistent state of the operating system (512) and server applications (514). The random access memory holds the currently running software and state of the operating system (518) and server applications (520).

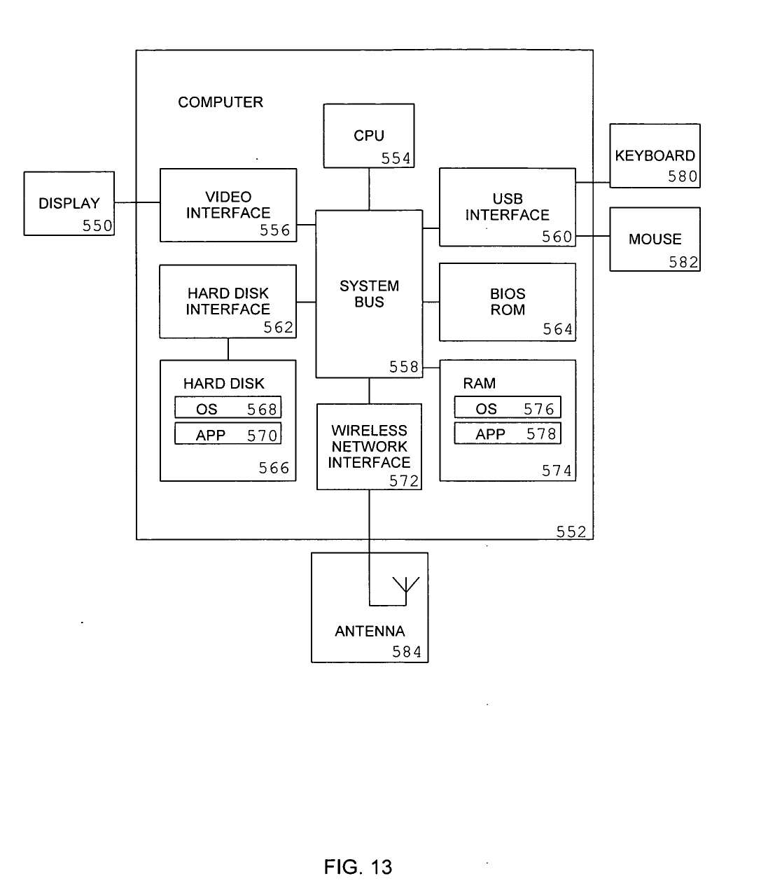

The diagram of FIG. 13 illustrates the typical components of a computer, such as mobile computer system, with a wireless network interface. The components of the computer (552) include a central processing unit (554), a video interface (556) to a display (550), a hard disk interface (562) to a hard disk (566), a USB interface (560) to a keyboard (580) and mouse (582), a BIOS ROM (564), a wireless network interface (572) and random access memory (574). The hard disk stores the persistent state of the operating system (568) and applications (570). The random access memory (574) holds the currently running software and state of the operating system (576) and applications (578).

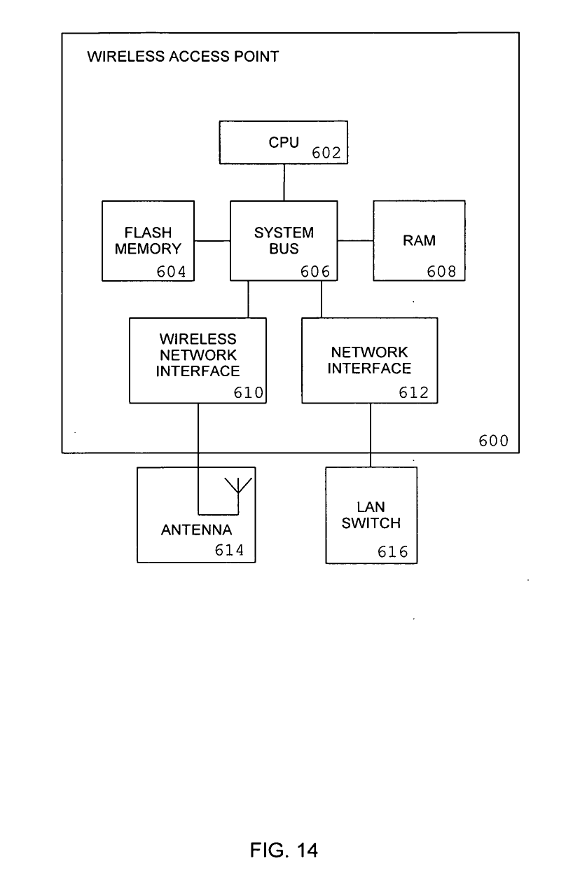

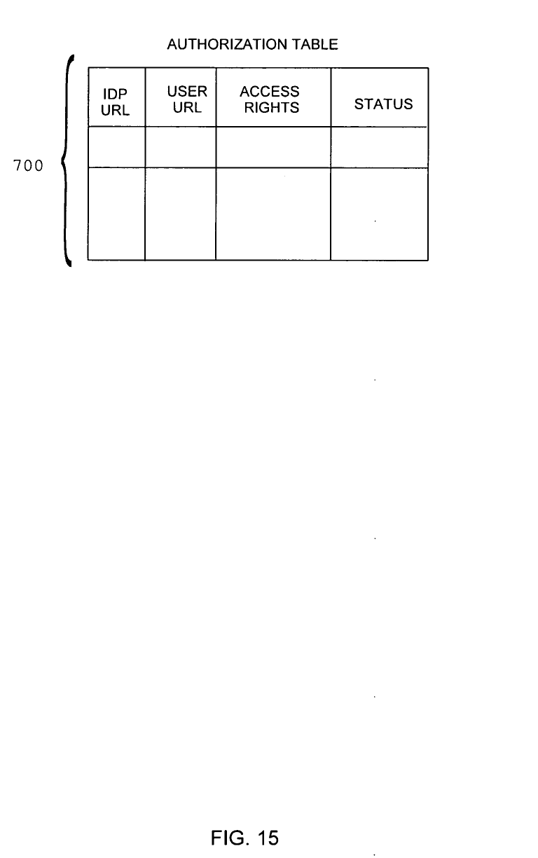

The diagram of FIG. 14 illustrates the typical components of a wireless access point. The components of a wireless access point (600) include a central processing unit (602), a system bus (606), flash memory (604), random access memory (608), a wireless network interface (610) with an antenna (614), and a network interface (612) to a LAN switch (616).

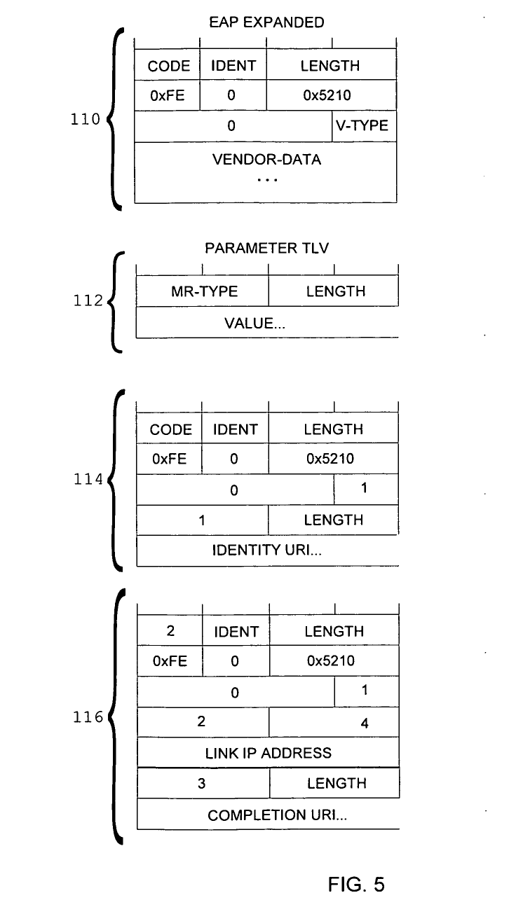

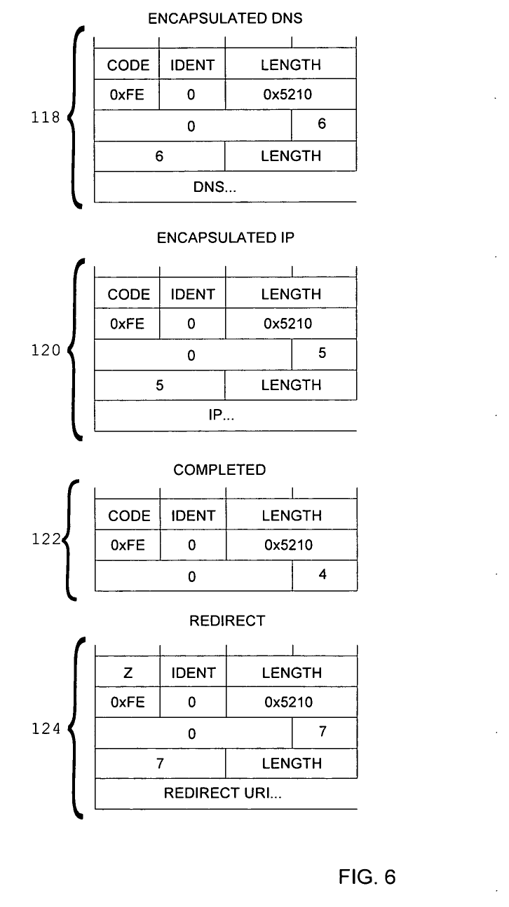

This invention defines five PDUs which can be carried in an EAP Expanded Type PDU (60), as illustrated in FIG. 5 and FIG. 6. In these PDUs, the Type is 0xFE and the Vendor ID is 0x5210.

Within a TLS channel established by PEAP, the local authentication server sends to the supplicant an EAP Request Expanded Type PDU with Vendor-Type of Request-URI (1), as illustrated by the Request-URI request PDU (116). The payload of this PDU is a TLV of MR-Type 2 comprising a link IP address, and a TLV or MR-Type 3 comprising a completion URI.

Within a TLS channel established by PEAP, the supplicant sends to the local authentication server an EAP Response Expanded Type PDU with Vendor-Type of Request-URI (1), as illustrated by the Request-URI reply PDU (114). The payload of this PDU is a TLV of MR-Type 1 of an identity URI comprising the OpenID identifier of the user.

Within a TLS channel established by PEAP, the local authentication server and supplicant may exchange domain name service requests and replies by sending an EAP Expanded Type PDU with Vendor-Type of Encap-DNS (6). In the Encapsulated DNS PDU (118), the Vendor-Type is 6, and one TLV parameter is present as the Vendor-Data: a DNS parameter of MR-Type 6. The value of the DNS parameter is a DNS message, as specified in the document IETF RFC 1035 “DOMAIN NAMES—IMPLEMENTATION AND SPECIFICATION” by P. Mockapetris of November 1987.

Within a TLS channel established by PEAP, the local authentication server and supplicant may exchange Internet Protocol datagrams by sending an EAP Expanded Type PDU with Vendor-Type of Encap-IP (5), as illustrated by the Encap-IP PDU (120). In the Encapsulated IP PDU (120), the Vendor-Type is 5, and one TLV parameter is present as the Vendor-Data: an IP parameter of MR-Type 5. The value of the IP parameter is an Internet Protocol PDU, as specified by the document IETF RFC 791 “INTERNET PROTOCOL” by J. Postel of September 1981.

Within a TLS channel established by PEAP, the local authentication server indicates to the supplicant that the OpenID authentication process has been completed by sending to the supplicant an EAP Request Expanded Type PDU with Vendor-Type of Completed (4), as illustrated by the Completed request PDU (122). The Vendor-Data is empty.

Within a TLS channel established by PEAP, the local authentication server indicates to the supplicant the redirect URI by sending the supplicant an EAP Request Expanded Type PDU with Vendor-Type of Redirect (7), as illustrated by the Redirect request PDU (124). One TLV parameter is present as the Vendor-Data: a parameter of MR-Type 7. The value of this parameter is a URI.

### Operation

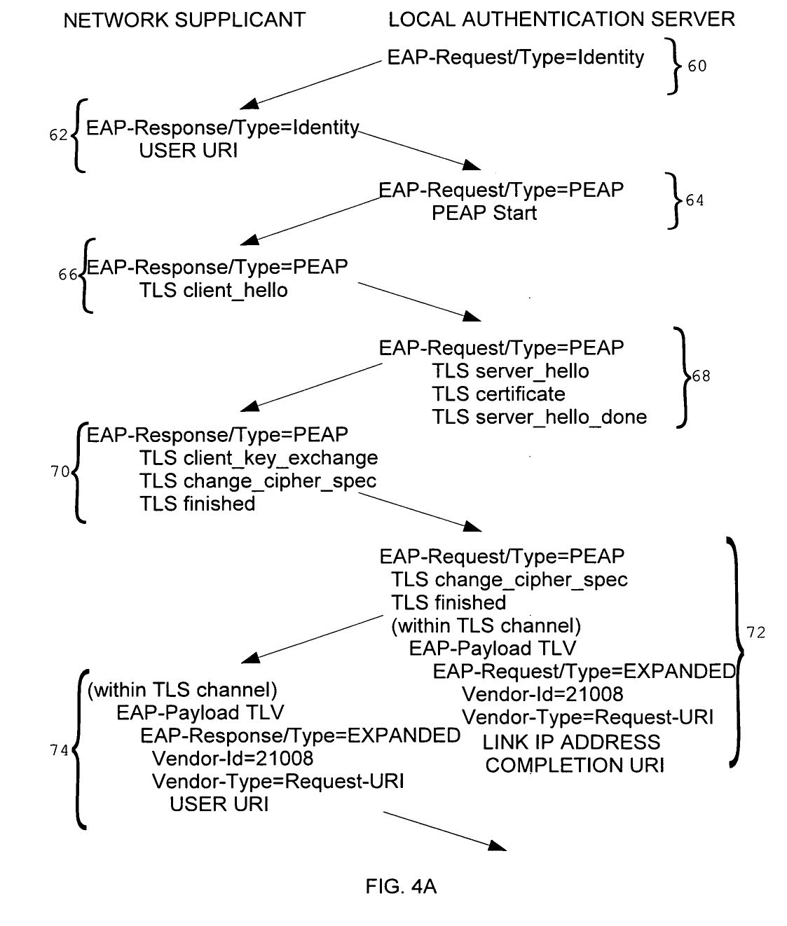

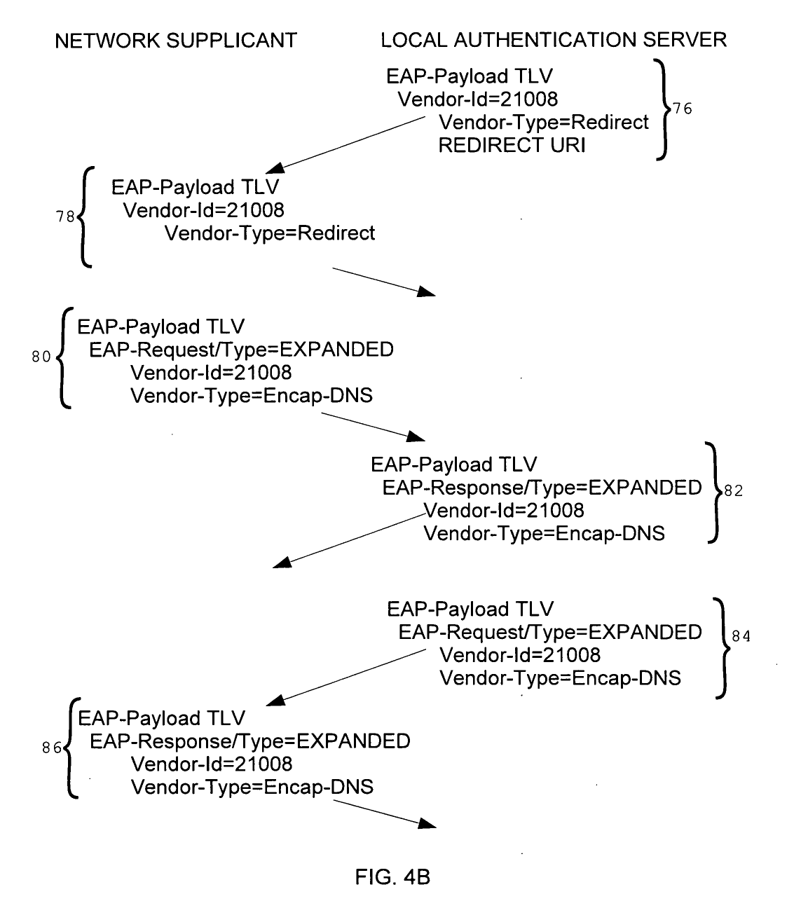

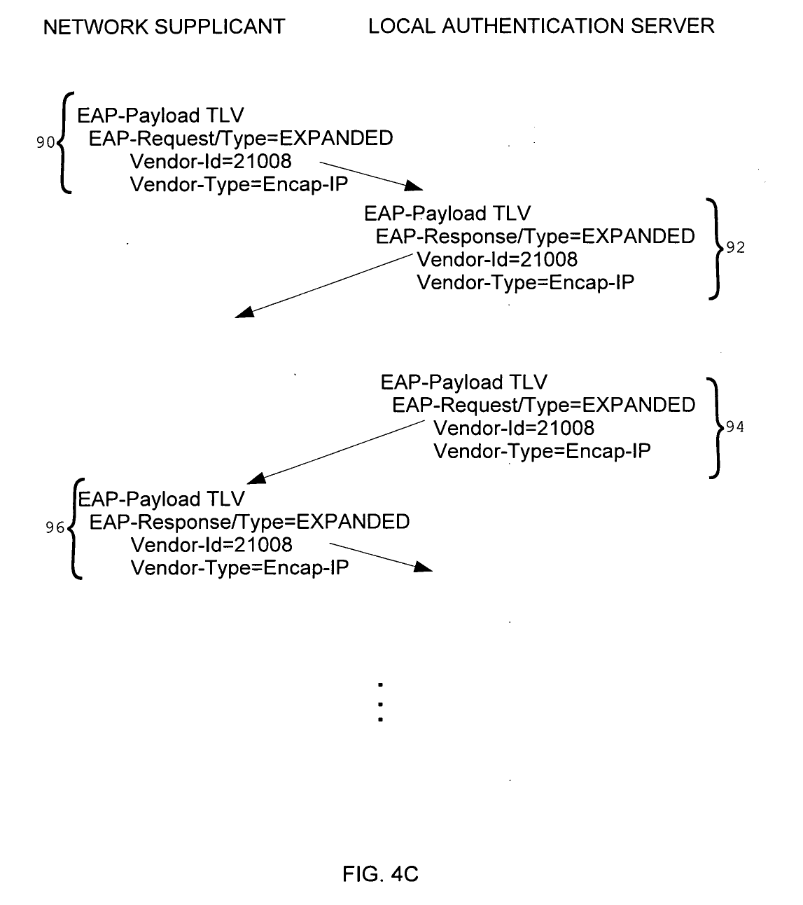

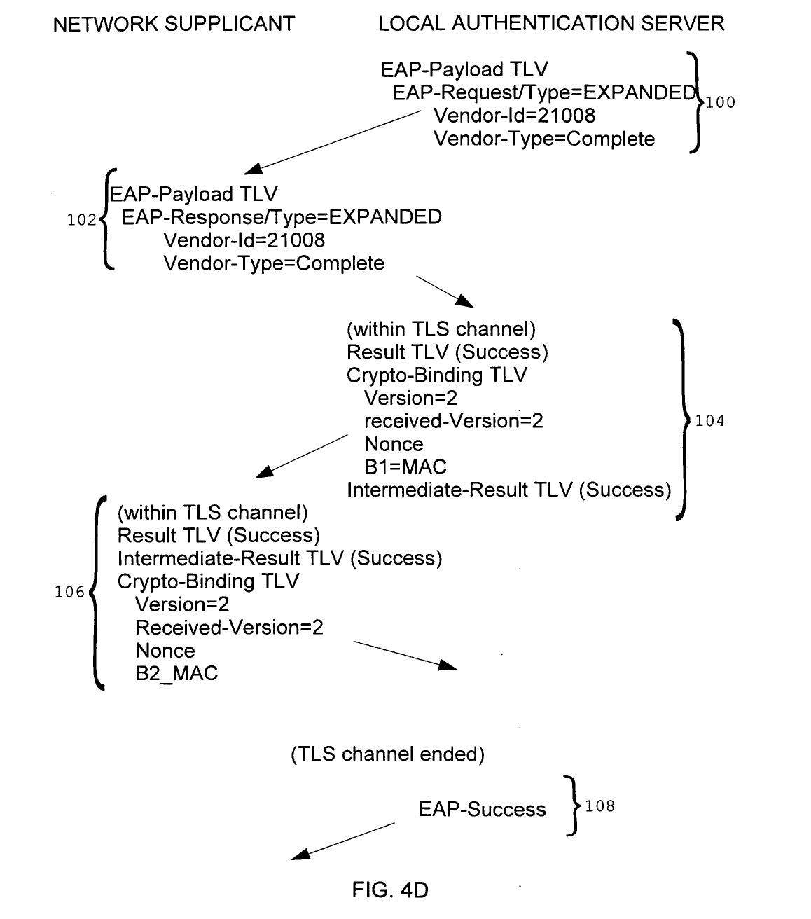

The sequence of EAP messages exchanged between a network supplicant (12) and the local authentication server (18) is illustrated by the diagrams of FIG. 4A, FIG. 4B, FIG. 4C and FIG. 4D.

The behavior of a network supplicant (12) is illustrated by the flowchart of FIG. 7A and FIG. 7B. This network supplicant comprises a single thread of control. This thread is started when the client (10) is commanded by the user or the client detects that it has connected to a network in which IEEE 802.1X is supported.

At step 132, when a client attaches to a network, the supplicant component of the client will receive notification from the authenticator that 802.1X authentication is necessary, and the supplicant thread will establish an 802.1X connection to the network access server. In the connection procedure, the network access server will send an EAP-Request/EAP-Type=Identity PDU to the supplicant, and the supplicant will reply with an EAP-Response/EAP-Type=Identity PDU. At step 134, if the connection cannot be established, the authentication process will have failed. Otherwise, at step 136, the supplicant will negotiate the use of PEAP and the PEAP-TLS mechanisms. In the negotiation procedure, the network access server will send an EAP-Request/EAP-Type=PEAP PDU with version=2, PEAP Start, and S bit set; the supplicant will reply with an EAP-Response/EAP-Type=PEAP PDU with version=2 and a TLS client_hello; the network access server will send an EAP-Request/EAP-Type=PEAP PDU with version=2, a TLS server_hello, a TLS certificate, a TLS server_hello_done; the supplicant will reply with an EAP-Response/EAP-Type=PEAP PDU with version=2, with a TLS client_key_exchange, a TLS change_cipher_spec, and a TLS finished; the network access server will send an EAP-Request/EAP-Type=PEAP PDU with a TLS change_cipher_spec and a TLS finished, and within the TLS channel, an EAP-Payload TLV with an EAP-Request/EAP-Type=EXPANDED PDU, with two parameters: a link IP address parameter, and a completion URI parameter. At step 138, if the TLS channel cannot be established, then the authentication process will have failed. Otherwise, subsequent messages are exchanged between the supplicant and the local authentication server. These messages are tunneled through the network access server and are encapsulated within the TLS channel.

At step 140, the thread will extract the link IP address parameter and the completion URI parameter from the PDU sent by the network access server following the PEAP and TLS negotiation. The thread will also receive from the network access server an EAP redirect request PDU (124) containing a redirect URI parameter. If these parameters could not be extracted, then at step 142 the authentication process will have failed.

At step 144, the thread will establish an encapsulated virtual network interface in the client operating system. The thread will set the local IP address of this interface to be the IP address provided by the local authentication server. The thread will advertise a default route to the Internet via this interface, and the thread will advertise that domain name service is available.

While the virtual network is present, the thread will:
wrap IP packets sent by applications on the client system to this interface in an encapsulated IP EAP Expanded PDU (120) and transmit them to the network access server to be forwarded to the local authentication server,
wrap DNS requests sent by applications on the client system in an encapsulated DNS EAP Expanded PDU (118) and transmit them to the network access server to be forwarded to the local authentication server,
unwrap incoming encapsulated DNS PDUs (118) from the network access server and provide the response DNS messages to the requesting application on the client system,
unwrap incoming encapsulated IP PDUs (120) from the network access server and provide the IP PDU to applications on the client system,
detect a completed PDU (122) sent by the network access server, and
detect when the TLS connection has been torn down, when the underlying EAP connection has been torn down, or the network connection has been lost.

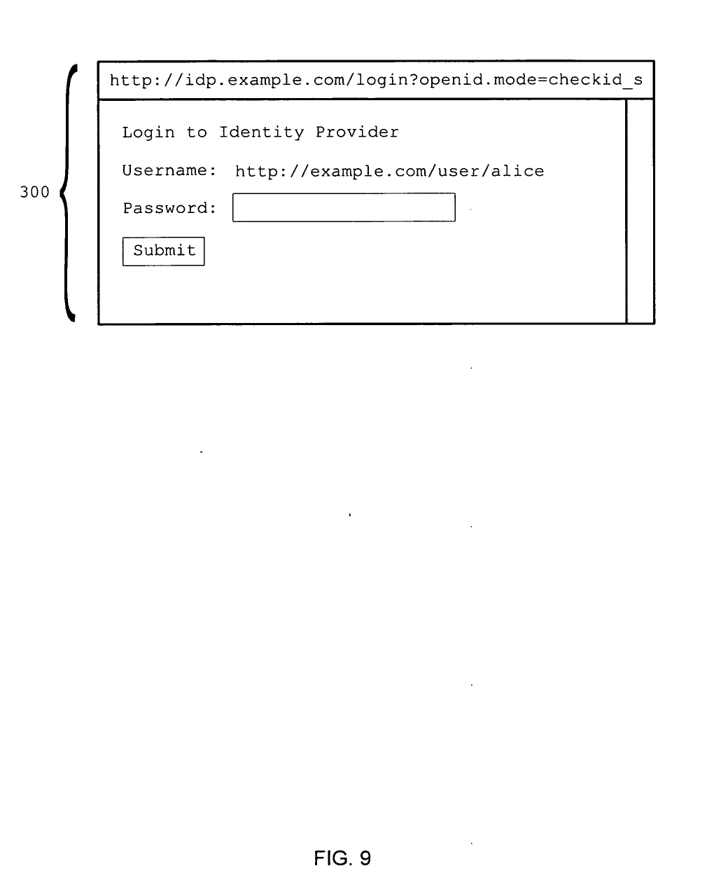

Once the virtual network interface is established, the thread will launch a web browser, and indicate to the web browser to visit the web page indicated by the redirect URI provided by the network access server. The user will authenticate to their identity provider via the interface provided by this web browser. An example of the user interface (300) generated by the identity provider and rendered by the web browser for display to the user is shown in FIG. 9.

At step 150, the thread will wait until one of the following events occurs: the web browser window is closed, a completed PDU is received from the network access server, or the TLS channel is terminated. If the web browser is closed, or the TLS channel is terminated, and a completed PDU was not received from the network access server, then at step 152 the authentication process will have failed. Otherwise, at step 154, the thread will terminate the TLS channel and wait for an EAP Success PDU from the network access server, or the EAP channel to be terminated. If an EAP Success PDU was not received from the network access server, then at step 156 the authentication process will have failed. Otherwise, at step 158 the authentication process will have completed and the thread will signal to the operating system that the network connection is available for use.

There are one or more threads of control in the local authentication server (18). The behavior of each thread in the local authentication server is illustrated by the flowchart of FIG. 8A, FIG. 8B, FIG. 8C and FIG. 8D. Each RADIUS conversation between the local authentication server and the network access server (16) is handled by one thread.

At step 172, the thread will wait for an incoming connection detection from the network access server (16). EAP interactions between the supplicant and the network access server are transported to the local authentication server in EAP-Message attributes within the RADIUS protocol. The detection is encoded as a RADIUS Access-Request PDU comprising an EAP-Message attribute in which the value of the attribute is an EAP Start PDU. The thread will reply to the network access server with a RADIUS Access-Challenge PDU comprising an EAP-Message attribute in which the value of the attribute is an EAP-Request/Identity PDU. The network access server will reply with a RADIUS Access-Request PDU comprising an EAP-Message attribute in which the value of the attribute is an EAP-Response/Identity PDU. At step 174, the thread will determine the EAP method for the specified identity. The thread will search in a table in the local database (22) for a record for the user identity. If a record is found, then at step 178 the thread will attempt authentication using an alternative EAP mechanism for this local user. If this was not successful or no alternative EAP mechanism is supported by the network access server, then the thread will fail the authentication.

Otherwise, if the PEAP EAP method is to be used, then at step 180 the thread will negotiate the PEAP and PEAP-TLS mechanisms. In the negotiation procedure, the thread will send an EAP-Request/EAP-Type=PEAP PDU with version=2, PEAP Start, and S bit set to the supplicant; the supplicant will reply with an EAP-Response/EAP-Type=PEAP PDU with version=2 and a TLS client_hello; the thread will send an EAP-Request/EAP-Type=PEAP PDU with version=2, a TLS server_hello, a TLS certificate, a TLS server_hello_done; the supplicant will reply with an EAP-Response/EAP-Type=PEAP PDU with version=2, with a TLS client_key_exchange, a TLS change_cipher_spec, and a TLS finished. At step 182, if the TLS channel could not be established, then at step 184 the thread will fail the authentication.

At step 186, the thread will establish an encapsulation tunnel for the client using network address translation. The thread will select an IP address for the client to use, and send this link IP and the completion URI to the supplicant via the network access server as an EAP Request-URI request PDU (116). The thread will then wait for the for the request URI to be returned by the supplicant in an EAP Request-URI reply PDU (114) tunneled by the network access server. If a URI was not returned by the supplicant, then at step 190 the thread will terminate the TLS channel and fail the authentication.

At step 194 the thread will establish a HTTP or HTTPS connection to the web server indicated by the request URI. The thread will retrieve over that connection a file identified by that URI, and the thread will then parse the file based on the HyperText Markup Language (HTML). HTML is defined in the document “HTML 4.01 Specification” by D. Raggett et al of December 1999. The thread will extract the values of the “href” attribute of “link” elements in the “head” section of the document in which the value of the “rel” attribute of the “link” element is “openid.server”. If the request URI was not a valid HTTP or HTTPS URI, the server could not be contacted, the server did not return an HTML document, or the document did not contain the specified “link” elements, then the thread will terminate the TLS channel and fail the authentication. Otherwise, at step 198 the thread will search the local database for a record for the OpenID identity provider server indicated by the “openid.server” value retrieved from the HTML. If no record was found, then the thread will terminate the TLS channel and fail the authentication.

Otherwise, at step 202 the thread will setup an association with the OpenID identity provider server, as described in section 4.1 of the document “OpenID Authentication 1.1” by D. Recordon et al of May 2006. If a response was not returned from the OpenID identity provider server, then the thread will terminate the TLS channel and fail the authentication.

At step 208, the thread will send an EAP Redirect PDU (124), in which the redirect URI encodes the request parameters of the OpenID checkid_setup operation, as described in section 4.3.1 of the document “OpenID Authentication 1.1” by D. Recordon et al of May 2006. At step 222, the thread will start a timer for the user to complete their authentication to their identity provider.

At step 224, the thread will relay encapsulated DNS and IP PDUs. If the thread receives an EAP Encap-DNS PDU (118), the thread will perform a DNS lookup as requested by the client, and respond to the supplicant with an EAP Encap-DNS PDU encapsulating the response DNS message. If the thread receives an EAP Encap-IP PDU (120), the thread will resend the contents of that PDU as a PDU on the Internet. If the thread receives a PDU from the Internet that is a response to a request PDU from a preceding EAP Encap-IP PDU, the thread will encapsulate this PDU and send it to the supplicant in an EAP Encap-IP PDU. The thread will stop relaying when one of the following events occurs:
the thread receives an encapsulated IP PDU in which the destination IP address is the IP address of the host of the completion URI and the protocol is TCP,
the timer indicates a timeout, or
the authentication process is terminated by the client or the network access server.

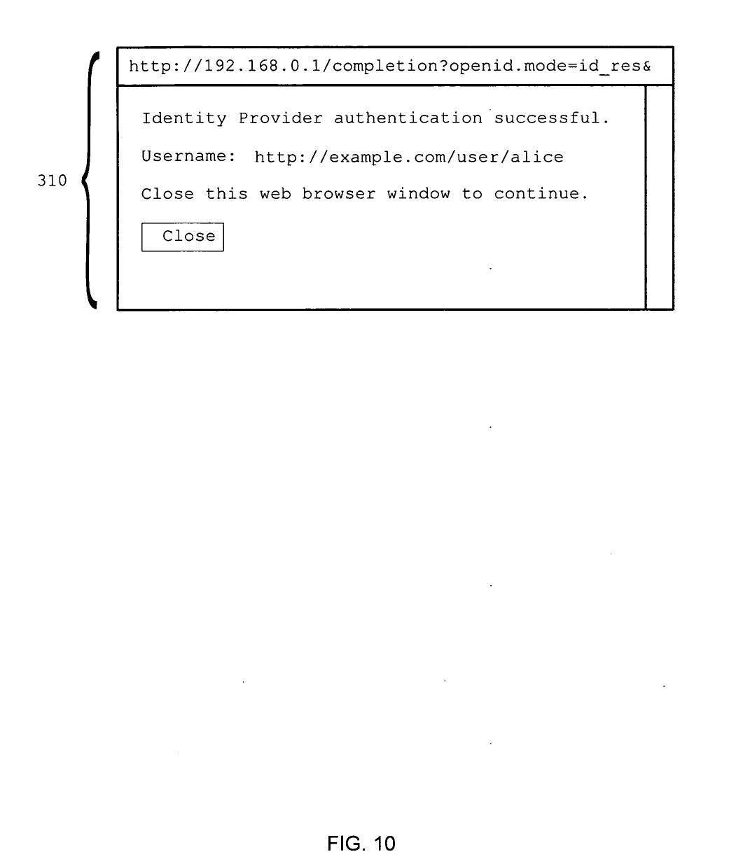

At step 228, if the relay step is terminated and the completion URI IP address had not been contacted, the thread will terminate the TLS channel and fail the authentication. Otherwise, at step 230 the thread will complete the TCP connection establishment for the completion URI by sending an encapsulated IP PDU to the network access server, and extract the parameters from the HTTP request carried within that encapsulated TCP connection. At step 250, the thread will validate the signature in the response, as described in section 4.3.2.2 and section 4.4 of the document “OpenID Authentication 1.1”. At step 252, if the signature was not present or was not validated, then the thread will terminate the TLS channel and fail the authentication. Otherwise, at step 254, the thread will check the user identity and authorization by searching the local database (22) authorization table (700) for a record which provides authorization for the specified user. If a record authorizing the user is not found, then the thread will terminate the TLS channel and fail the authentication. Otherwise, at step 257, the thread will send an HTML response page and close the encapsulated TCP connection. An example of the HTML response page user interface (310) generated by the thread and rendered by the web browser for display to the user is shown in FIG. 10. At step 258, the thread will send EAP completion PDU (122), terminate the TLS channel, and send the EAP success indication to the network access server. At step 262 the thread will specify the network filter rules in a response to the network access server.

### CONCLUSIONS

Many different embodiments of this invention may be constructed without departing from the scope of this invention. While this invention is described with reference to various implementations and exploitations, and in particular with respect to systems for authentication in computer networks, it will be understood that these embodiments are illustrative and that the scope of the invention is not limited to them.

What is claimed is:

1. A method for authenticating a client to a network access server, said method comprising
(a) connecting said client to said network access server,
(b) transmitting from said client to said network access server an identity,
(c) forwarding said identity from said network access server to a local authentication server,
(d) locating an identity provider web server responsible for authenticating said client with said identity,
(e) transmitting from said local authentication server to said client a redirect address,
(f) establishing a tunnel to permit access from said client to said identity provider web server via said network access server and said local authentication server,
(g) transmitting from said client to said identity provider web server within said tunnel an authentication request comprising said identity and comprising said redirect address,
(h) authenticating said client at said identity provider web server based on said authentication request,
(i) transmitting from said identity provider web server to said client within said tunnel a response,
(j) transmitting from said client to said local authentication server said response,
(k) validating said response at said local authentication server, and
(l) transmitting from said local authentication server to said network access server a configuration to permit network access by said client.

2. The method of claim 1, wherein transmitting from said local authentication server to said network access server said configuration to permit network access comprises transmitting an access policy from said local authentication server to said network access server within a message encoded in a remote access dial in user service protocol.

3. The method of claim 1, wherein transmitting from said client to said identity provider web server said authentication request comprises transmitting a credential from said client to said identity provider web server.

4. The method of claim 3, wherein authenticating said client comprises comparing said identity and said credential with a record corresponding to said identity obtained from a database of said identity provider web server.

5. The method of claim 1, wherein locating said identity provider web server comprises retrieving a document from an address corresponding to said identity.

6. The method of claim 1, wherein transmitting from said client to said local authentication server said response comprises transmitting said response in a hypertext transfer protocol.

7. The method of claim 1, wherein establishing said tunnel comprises configuring said client to encode messages destined to said identity provider web server within an extensible authentication protocol.

8. A system for authenticating a client to a network access server, said system comprising
(a) said client,
(b) said network access server,
(c) a local authentication server, and
(d) an identity provider web server, wherein
said client connects to said network access server,
said client transmits an identity to said network access server,
said network access server forwards said identity to said local authentication server,
said local authentication server locates said identity provider web server responsible for authenticating said client with said identity,
said local server transmits a redirect address to said client,
said local authentication server establishes a tunnel to permit access by said client to said identity provider web server,
said client transmits within said tunnel an authentication request comprising said redirect identity and comprising said redirect address to said identity provider web server,
said identity provider web server authenticates said client based on said authentication request,
said identity provider web server transmits within said tunnel a response to said client,
said client transmits said response to said local authentication server,
said local authentication server validates said response, and
said local authentication server configures said network access server to permit network access to said client.

9. The system of claim 8, wherein said local authentication server is implemented as software running on a general-purpose computer system.

10. The system of claim 8, wherein said identity comprises a uniform resource locator.

11. The system of claim 8, wherein said redirect address comprises a uniform resource locator.

12. The system of claim 8, wherein said client transmits within said tunnel an authentication request further comprising a credential.

13. The system of claim 12, wherein said identity provider web server authenticates said client by comparing said identity and said credential with a record corresponding to said identity obtained from a database of said identity provider web server.

14. A computer program product within a computer usable medium with software for authenticating a client to a network access server, said computer program product comprising
(a) instructions connecting said client to said network access server,
(b) instructions for transmitting from said client to said network access server an identity,
(c) instructions for forwarding said identity from said network access server to a local authentication server,
(d) instructions for locating an identity provider web server responsible for authenticating said client with said identity,
(e) instructions for transmitting from said local authentication server to said client a redirect address,
(f) instructions for establishing a tunnel to permit access from said client to said identity provider web server via said network access server and said local authentication server,
(g) instructions for transmitting from said client to said identity provider web server within said tunnel an authentication request comprising said identity and comprising said redirect address,
(h) instructions for authenticating said client at said identity provider web server based on said authentication request,
(i) instructions for transmitting from said identity provider web server to said client within said tunnel a response,
(j) instructions for transmitting from said client to said local authentication server said response,
(k) instructions for validating said response at said local authentication server, and
(l) instructions for transmitting from said local authentication server to said network access server a configuration to permit network access by said client.
